(19) United States
(12) Patent Application Publication
(10) Pub. No.: US 2007/0241522 A1
(43) Pub. Date: Oct. 18, 2007

(54) Active automobile turn gravity change control apparatus

(76) Inventor: Tsang-Chao Tsai, Taichung County (TW)

Correspondence Address: BIRCH STEWART KOLASCH & BIRCH, PO BOX 747, FALLS CHURCH, VA, 22040-0747, US

(21) Appl. No.: 11/402,811

(22) Filed: Apr. 13, 2006

(51) Int. Cl. B62D 9/02; B60G 17/00; B60G 21/00

(52) U.S. Cl. 280/5.509; 280/6.16; 280/124.103

(57) ABSTRACT

An active automobile turn gravity change control apparatus installs an elevating mechanism between each of four wheels and an automobile body of an automobile, and the elevating mechanism is driven by a motive power supply element and controlled by a controller to adjust the relative distance between each of the four wheels and the automobile body, so that when the automobile makes a turn, the controller detects the turning direction and speed of the automobile to actively adjust the elevating mechanism to change the inclining direction and extent of the automobile body and shift the center of gravity of the automobile towards the internal side of the curve of turning, so as to resist the inertia force produced by a turn of the automobile, achieve a safe and quick turn, and prevent a car overturn accident.

### FIELD OF THE INVENTION

The present invention relates to an apparatus of an automobile suspension system, and more particularly to an apparatus that changes the inclination of the automobile body when an automobile makes a turn, so as to make a safe quick turn and prevent car overturns or accidents.

### BACKGROUND OF THE INVENTION

In general, an automobile suspension system is installed between four tires and an automobile body, such that when an automobile is driven on a road, the suspension system moderates the shocks and vibrations produced by rough roads to protect the safety of the automobile structure and make the ride comfortable for the driver and passengers in the automobile. The rigidity of the suspension system directly affects the control of driving the automobile and the passenger's comfortability. In general, the softer the suspension system, the more comfortable is the ride, but the lesser control is the driving. Particularly, when a turn is made, a softer suspension system tends to have a larger outward inclination and the automobile body tilts more to the outside, and thus causing a loss of control of the automobile or even a car overturn or accident easily.

Referring to FIG. 1 for the R.O.C. Pat. Publication No. 142628, the patent discloses an “automobile suspension system torque suppressing apparatus”, such that when a turn is made and the suspension system bears the moment of inertia, the suspending apparatus 1 uses its strain elasticity to suppress the reaction of the strain elasticity and reduce the shift of center of gravity of the automobile body, so as to improve the driving safety.

Referring to FIG. 2 for the R.O.C. Pat. Publication No. 550197, the patent provides an “automobile body level control system” that uses a pneumatic transmission device 2 to transmit a mechanical means such as a hydraulic pressure or a link rod to hold up the wheels of a same axle or different axles and control the holding force to fit different roads, so as to maintain the level and balance of the automobile body and give consideration to the requirements for different road conditions.

Both of the foregoing prior arts can improve the shift of the center of gravity while an automobile is making a turn to improve the driving safety and lower the opportunity of a car overturn or accident. However, these prior arts use the holding force among different wheels to passively keep the automobile body level when the automobile is making a turn and having a shift of the center of gravity, and it thus can achieve a very limited effect only. If there is an emergency situation on the road and it is necessary to dodge an accident by making a quick turn, the passive prior arts usually do not provide a quick response fast enough to avoid the accident and may result a car overturn.

### SUMMARY OF THE INVENTION

The primary objective of the present invention is to overcome the foregoing shortcomings and avoid the existing deficiencies by providing an active automobile body gravity change control apparatus that detects the speed and turning direction of an automobile to timely and actively tilt the automobile body to reduce the shift of the center of gravity of the automobile body and lowers the possibility of a car overturn or accident.

The present invention provides an active automobile turn gravity change control apparatus that is applied to an automobile and comprises an elevating mechanism, a motive power supply element and a controller, wherein the elevating mechanism is installed between a wheel and an automobile body of an automobile, and the motive power supply element drives the elevating mechanism to move, and the controller is connected to the motive power supply element, and the controller controls the motive power supply element according to the turning direction and speed of the automobile to control the movement of the elevating mechanism, so as to change the relative distance between the wheel and automobile body of the automobile.

Thus, the invention installs an elevating mechanism between the each of the four wheels, and the automobile body uses the controller to control the movements of the four elevating mechanisms respectively by the four motive power supply elements according to the turning direction and speed of the automobile, so as to adjust the inclining direction and extent of the automobile body of the automobile to actively adjust the center of gravity of the automobile body and effectively reduce the shift of center of gravity of the automobile body while the automobile is making a turn.

### BRIEF DESCRIPTION OF THE DRAWINGS

FIG. 1 is a schematic view of an application according to R.O.C. Pat. No. 142628;

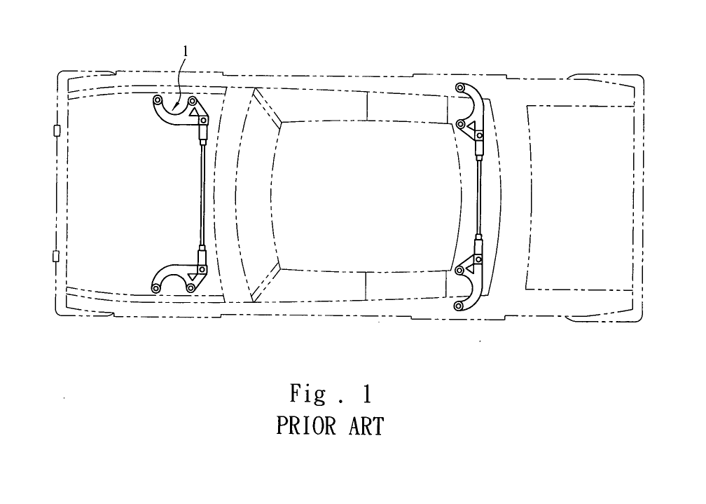

FIG. 2 is a schematic view of a layout according to R.O.C. Pat. No. 550197;

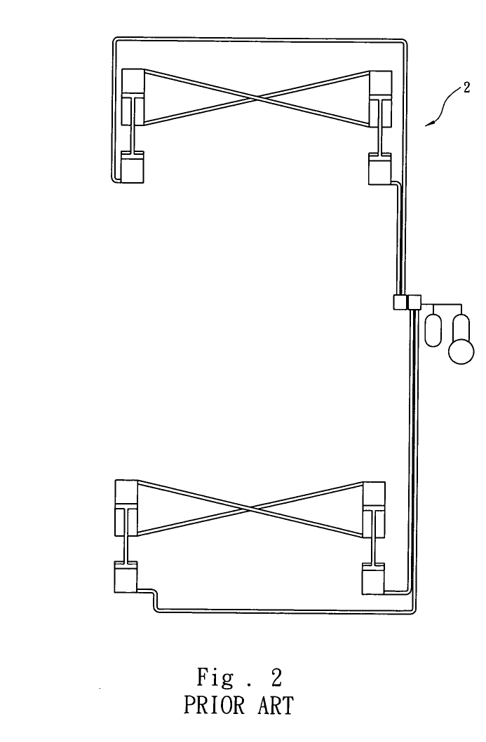

FIG. 3 is a schematic view of the architecture of a first preferred embodiment of the present invention;

FIG. 4 is a schematic view of the architecture of a second preferred embodiment of the present invention;

FIG. 5 is a schematic view of the architecture of a third preferred embodiment of the present invention; and

FIG. 6 is a schematic view of the movements when an automobile makes a turn according to the present invention.

### DETAILED DESCRIPTION OF THE PREFERRED EMBODIMENTS

The present invention will now be described in more detail hereinafter with reference to the accompanying drawings as follows:

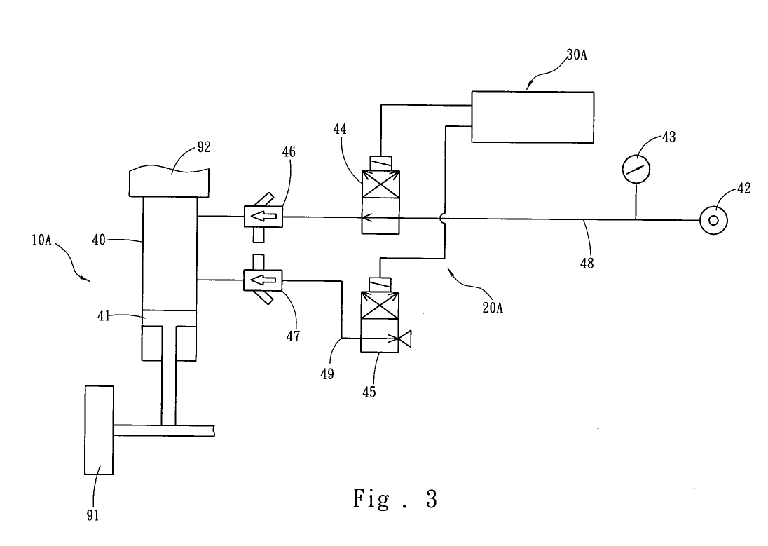

Referring to FIG. 3, a first preferred embodiment of the present invention comprises: an elevating mechanism 10A, a motive power supply element 20A and a controller 30A. The elevating mechanism 10A is installed between a wheel 91 and an automobile body 92 of an automobile 90. The elevating mechanism 10A includes a pneumatic cylinder 40 and a pneumatic push rod 41, and the motive power supply element 20A includes an air pressure source 42, a pressure gauge 43, an incoming air solenoid valve 44, an outgoing air solenoid valve 45, an incoming air speed adjusting valve 46 and an outgoing air speed adjusting valve 47, wherein the pneumatic push rod 41 is slidably installed in the pneumatic cylinder 40, and the air pressure source 42 uses an incoming air pipe 48 to interconnect with the pneumatic cylinder 40, and the incoming air pipe 48 includes the incoming air solenoid valve 44, the incoming air speed adjusting valve 46 and the pressure gauge 43. The pneumatic cylinder 40 includes an outgoing air pipe 49 interconnected to the outside, and the outgoing air pipe 49 includes the outgoing air solenoid valve 45 and the outgoing air speed adjusting valve 47.

The motive power supply element 20A is controlled by turning on or off the incoming air solenoid valve 44 and the outgoing air solenoid valve 45 to change the pressure of the pneumatic cylinder 40 for driving the elevating mechanism 10A to move. The controller 30A is connected to the motive power supply element 20A, and thus the controller 30A can control the movement of the motive power supply element 20A to further control the movement of the elevating mechanism 10A.

In the structure as illustrated in the first preferred embodiment, there are four elevating mechanisms 10A and four motive power supply elements 20A, so that an elevating mechanism 10A is installed between each of the four wheels 91 of the automobile 90 and the automobile body 92, and the controller 30A can control the movements of the four elevating mechanisms 10A through the four motive power supply elements 20A according to the turning direction and speed of the automobile 90, so as to adjust the inclining direction and extent of the automobile body 92 of the automobile 90.

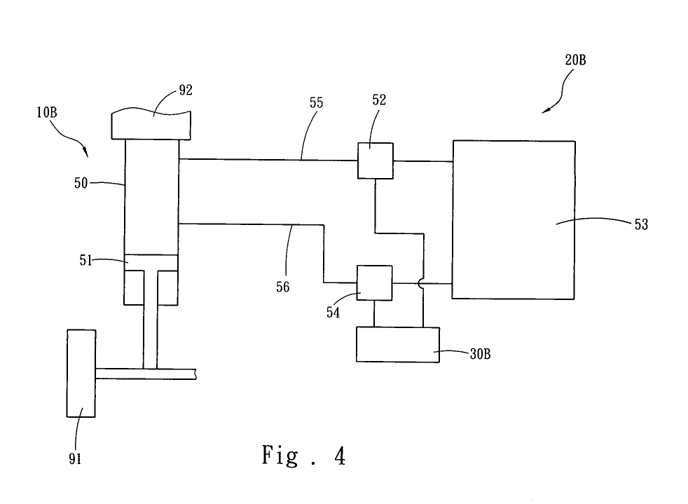

Referring to FIG. 4, a second preferred embodiment of the present invention comprises: an elevating mechanism 10B, a motive power supply element 20B and a controller 30B, and the elevating mechanism 10B is installed between a wheel 91 and an automobile body 92 of an automobile 90. The elevating mechanism 10B includes a hydraulic cylinder 50 and a hydraulic push rod 51, and the motive power supply element 20B includes a hydraulic pump 52, a hydraulic tank 53 and an oil relief valve 54, wherein the hydraulic push rod 51 is slidably installed in the hydraulic cylinder 50, and the hydraulic tank 53 includes an incoming oil pipe 55 interconnected with the hydraulic cylinder 50, and the incoming oil pipe 55 installs the hydraulic pump 52, and the hydraulic tank 53 includes an outgoing oil pipe 56 interconnected with the hydraulic cylinder 50, and the outgoing oil pipe 56 installs the oil relief valve 54. Therefore, the motive power supply element 20B can control the oil quantity in the hydraulic cylinder 50 by the hydraulic pump 52 and the oil relief valve 54 to drive the elevating mechanism 10B to move vertically up and down, and the controller 30B is connected to the motive power supply element 20B, and thus the controller 30B can control the motive power supply element 20B to change the oil quantity in the hydraulic cylinder 50 to control the movement of the elevating mechanism 10B.

In the structure as illustrated in the second preferred embodiment, there are four elevating mechanisms 10B and four motive power supply elements 20B, so that one elevating mechanism 10B can be installed between each of the four wheels 91 and the automobile body 92 of the automobile 90, and the controller 30B can control the movements of the four elevating mechanisms 10B by the four motive power supply elements 20B according to the turning direction and speed of the automobile 90 to adjust the inclining direction and extent of the automobile body 92 of the automobile 90.

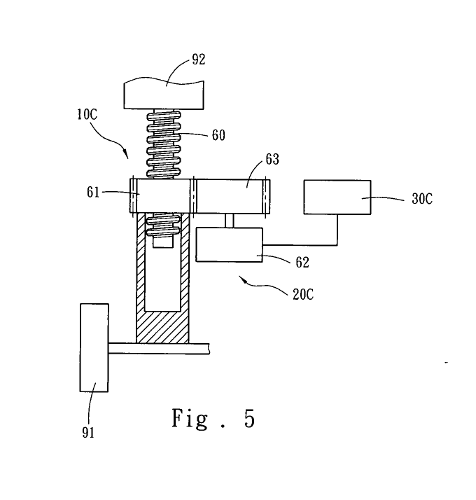

Referring to FIG. 5, a third preferred embodiment of the present invention comprises: an elevating mechanism 10C, a motive power supply element 20C and a controller 30C, and the elevating mechanism 10C is installed between a wheel 91 and an automobile body 92 of an automobile 90. The elevating mechanism 10C includes a screw rod 60 and a screw gear 61, and the motive power supply element 20C includes a servomotor 62 and a gear 63, wherein the screw rod 60 is engaged with the screw gear 61, and the servomotor 62 is connected to the gear 63 for synchronous rotations, and the gear 63 is engaged with the screw gear 61 and driven by the servomotor 62 to rotate. Therefore, the motive power supply element 20C can be rotated by the servomotor 62 through the screw gear 61 driven by the gear 63 to move the elevating mechanism 10C. The controller 30C is connected to the motive power supply element 20C, so that the controller 30C can control the motive power supply element 20C to further control the movement of the elevating mechanism 10C.

In the structure as illustrated in the third preferred embodiment, there are four elevating mechanisms 10C and four motive power supply elements 20C, and one elevating mechanism 10C is installed between each of the four wheels 91 and the automobile body 92, and the controller 30C controls the movements of the four elevating mechanisms 10C by the four motive power supply elements 20C according to the turning direction and speed of the automobile 90 to adjust the inclining direction and extent of the automobile body 92 of the automobile 90.

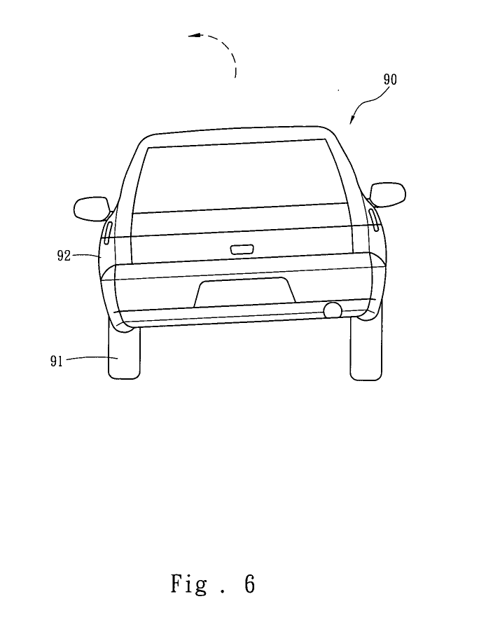

Referring to FIG. 6 for the automobile 90 according to any one of the foregoing three preferred embodiment that makes a turn, the controllers 30A, 30B, 30C controls the movements of the elevating mechanisms 10A, 10B, 10C by the motive power supply elements 20A, 20B, 20C according to the turning direction and speed of the automobile 90 to adjust the inclining direction and extent of the automobile body 92 of the automobile 90, so that the center of gravity of the automobile body 92 can be adjusted actively to reduce the shift of the center of gravity of the automobile body 92 timely and effectively. Thus, the present invention can provide an active protective measure to improve the driving safety when an automobile is making a turn.

What is claimed is:

1. An active automobile turn gravity change control apparatus, which is applied to an automobile, comprising:
an elevating mechanism, disposed between a wheel and an automobile body of said automobile;
a motive power supply element, for driving said elevating mechanism to move vertically up and down, so as to change the height of a wheel suspension system of said automobile;
a controller, coupled to said motive power supply element for controlling said motive power supply element according to the turning direction and speed of said automobile to ascend or descend said elevating mechanism.

2. The active automobile turn gravity change control apparatus of claim 1, wherein said elevating mechanism includes a pneumatic cylinder and a pneumatic push rod, and said motive power supply element includes an air pressure source, a pressure gauge, an incoming air solenoid valve, an outgoing air solenoid valve, an incoming air speed adjusting valve and an outgoing air speed adjusting valve, and said pneumatic push rod is slidably installed in said pneumatic cylinder, and said air pressure source uses an incoming air pipe to interconnect said pneumatic cylinder, and said incoming air pipe includes said incoming air solenoid valve, said incoming air speed adjusting valve and said pressure gauge, and said pneumatic cylinder has an outgoing air pipe interconnected to the outside, and said outgoing air pipe installs said outgoing air solenoid valve and said outgoing air speed adjusting valve.

3. The active automobile turn gravity change control apparatus of claim 1, wherein said elevating mechanism includes a hydraulic cylinder and a hydraulic push rod, and said motive power supply element includes a hydraulic pump, a hydraulic tank and an oil relief valve, and said hydraulic push rod is slidably installed in said hydraulic cylinder, and said hydraulic tank includes an incoming oil pipe interconnected with said hydraulic cylinder, and said incoming oil pipe installs said hydraulic pump, and said hydraulic tank includes an outgoing oil pipe interconnected with said hydraulic cylinder, and said outgoing oil pipe installs said oil relief valve.

4. The active automobile turn gravity change control apparatus of claim 1, wherein said elevating mechanism includes a screw rod and a screw gear, and said motive power supply element includes a servomotor and a gear, and said screw rod is engaged with said screw gear, and said servomotor and said gear are coupled for synchronous rotations, and said gear is engaged with said screw gear and driven by said servomotor to rotate.

5. The active automobile turn gravity change control apparatus of claim 1, wherein said elevating mechanism and said motive power supply element come with four pieces each, and an elevating mechanism is installed between each of the four wheels and said automobile body of said automobile, and said controller controls the movements of said four elevating mechanisms according to the turning direction and speed of said automobile, so as to adjust the inclining direction and extent of said automobile body of said automobile.
